(19) United States
(12) Patent Application Publication
(10) Pub. No.: US 2016/0026396 A1
(43) Pub. Date: Jan. 28, 2016

(54) SEMICONDUCTOR MEMORY APPARATUS AND ELECTRONIC SYSTEM HAVING THE SAME

(71) Applicant: SK hynix Inc., Gyeonggi-do (KR)

(72) Inventor: Hae Chan PARK, Gyeonggi-do (KR)

(21) Appl. No.: 14/504,228

(22) Filed: Oct. 1, 2014

(30) Foreign Application Priority Data
Jul. 24, 2014 (KR) 10-2014-0094137

(51) Int. Cl. G06F 3/06; H04B 7/24

(52) U.S. Cl. CPC G06F 3/0613; G06F 3/0655; G06F 3/0673; H04B 7/24

(57) ABSTRACT

A semiconductor memory apparatus includes a memory circuit unit, a radio frequency (RF) signal unit which wirelessly transmits and receives signals, and a control circuit unit which accesses the memory circuit unit in response to a signal received through the RF signal unit and provides data of the memory circuit unit to the RF signal unit. At least one of the RF signal unit and the control circuit unit has a one-chip structure with the memory circuit unit.

### CROSS-REFERENCES TO RELATED APPLICATION

This application claims priority under 35 U.S.C. 119(a) to Korean application No. 10-2014-0094137 filed on Jul. 24, 2014, in the Korean intellectual property Office, which is incorporated by reference in its entirety as set forth in full,

### BACKGROUND

1. Technical Field

Various embodiments relate to a semiconductor integrated circuit, and more particularly, to a semiconductor memory apparatus and an electronic system having the same.

2. Related Art

One of the indicators which evaluate performance of semiconductor memory apparatuses is operation time. The operation speed may be determined by bandwidths of the semiconductor memory apparatuses, and the bandwidth depends on clock frequency and the number of data buses. That is, as the clock frequency is increased, and the number of data buses is increased, the bandwidth is increased, and the semiconductor memory apparatuses may operate at high speed. The data buses may be referred to as bidirectional wirings for input/output (I/O) of data between the semiconductor memory apparatuses and the external apparatuses.

To improve the operation speed of the semiconductor memory apparatuses, research for increasing the number of data buses or manufacturing the memory apparatuses in a stacked chip structure have been made.

Currently, data buses may be designed in a wired manner, and thus there is a limit on the number of data buses which can be formed in a memory chip having a limited size,

### SUMMARY

According to an embodiment, there is provided a semiconductor memory apparatus. The semiconductor memory apparatus may include a memory circuit unit, a radio frequency (RF) signal unit which wirelessly transmits and receives signals, and a control circuit unit which accesses to the memory circuit unit in response to a signal received through the RF signal unit and provides data of the memory circuit unit to the RF signal unit. At least one of the RF signal unit and the control circuit unit may have a one-chip structure with the memory circuit unit.

According to an embodiment there is provided an electronic system. The electronic system may include a first chip including a radio frequency (RF) transceiving unit, and at least one second chip which wirelessly transmits and receives signals to and from the first chip. The second chip may include a memory circuit unit, a radio frequency (RF) signal unit which wirelessly transmits and receives signals, and a control circuit unit which accesses to the memory circuit unit in response to a signal received through the RF signal unit and provides data of the memory circuit unit to the RF signal unit. At least one of the RF signal unit and the control circuit unit may have a one-chip structure with the memory circuit unit,

According to an embodiment, there is provided an electronic system. The electronic system may include a processor which performs decoding on a command input from an external apparatus, a memory controller which wirelessly transmits and receives signals to and from a memory apparatus according to control of the processor, and the memory apparatus including a memory circuit unit, a radio frequency (RF) signal unit which wirelessly transmits and receives signals to and from the memory controller, and a control circuit unit which accesses to the memory circuit unit in response to a signal received through the RF signal unit and provides data of the memory circuit unit to the RF signal unit. At least one of the RF signal unit and the control circuit unit may have a one-chip structure with the memory circuit unit.

According to an embodiment, there is provided an electronic system. The electronic system may include a memory apparatus including a memory circuit unit, a radio frequency (RF) signal unit which wirelessly transmits and receives signals, and a control circuit unit which accesses to the memory circuit unit in response to a signal received through the RF signal unit and provides data of the memory circuit unit to the RF signal unit, wherein at least one of the RF signal unit and the control circuit unit has a one-chip structure with the memory circuit unit, a memory controller which wirelessly transmits and receives signals to and from the control circuit unit, and controls an operation of the memory apparatus, and a card interface which performs data exchange between a host and the memory controller.

These and other features, aspects, and embodiments are described below in the section entitled “DETAILED DESCRIPTION”

### BRIEF DESCRIPTION OF THE DRAWINGS

The above and other aspects, features and advantages of embodiments will be more dearly understood from the following detailed description taken in conjunction with the accompanying drawings, in which:

FIG. 1 is a view illustrating a configuration of a semiconductor memory apparatus according to an embodiment;

FIG. 2 is a view illustrating a configuration of a semiconductor memory apparatus according to an embodiment;

FIG. 3 is a view illustrating a configuration of a semiconductor memory apparatus according to an embodiment;

FIG. 4 is a view illustrating a configuration of an RE signal unit and a control circuit unit according to an embodiment;

FIG. 5 is a view illustrating a configuration of a control circuit unit according to an embodiment;

FIG. 6 is a view illustrating a configuration of an RF signal unit according to an embodiment;

FIG. 7 is a view illustrating a configuration of voltage generation unit of FIG. 6;

FIG. 8 is a view illustrating a one-chip structure of a semiconductor memory apparatus according to an embodiment;

FIG. 9 is a view illustrating a configuration of a semiconductor memory apparatus according to an embodiment;

FIG. 10 is a view illustrating a configuration of a semiconductor memory apparatus according to an embodiment;

FIG. 11 is a view illustrating a configuration of an electronic system according to an embodiment;

FIG. 12 is a view illustrating a configuration f an electronic system according to an embodiment; and

FIG. 13 is a view illustrating a configuration of an electronic system according to an embodiment.

### DETAILED DESCRIPTION

Exemplary embodiments will be described in greater detail with reference to the accompanying drawings. Exemplary embodiments are described herein with reference to cross-sectional illustrations that are schematic illustrations of exemplary embodiments (including intermediate structures). As such, variations from the illustrations in shape due to differences in, for example, manufacturing techniques and/or tolerances, are to be expected. Thus, embodiments should not be construed as limited to the particular shapes illustrated herein but may include modifications. In the drawings, lengths and sizes of layers and regions may be exaggerated for clarity. Like reference numerals in the drawings denote like elements. It is also understood that when a layer is referred to as being “on” another layer or substrate, it can be directly on the other layer or substrate, or intervening layers may also be present. It is also noted that in this specification, “connected/coupled” refers to where one component is connected/coupled to another component either directly or indirectly, through an intermediate component. In addition, a singular form may include a plural form, and vice versa, as long as it is not specifically mentioned otherwise.

Embodiments are described herein with reference to cross-section and/or plan illustrations that are schematic illustrations. However, embodiments should not be construed as limited thereto. Although a few embodiments will be shown and described, it will be appreciated that changes may be made in these exemplary embodiments,

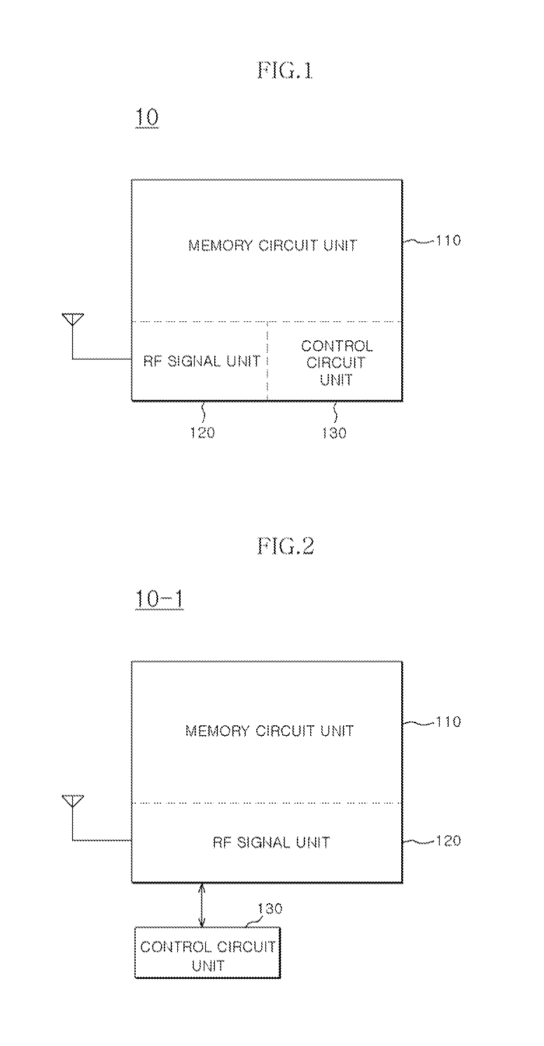

FIGS. 1 to 3 are views illustrating configurations of semiconductor memory apparatuses according to embodiments.

A semiconductor memory apparatus 10 illustrated in FIG. 1 may include a memory circuit unit 110 formed in a first region of a semiconductor substrate, a radio frequency (RF) signal unit 120 formed in a second region of the semiconductor substrate, and a control circuit unit 130 formed in a third region of the semiconductor substrate. The memory circuit unit 110, the RF signal unit 120, and the control circuit unit 130 may be formed in one chip.

The memory circuit unit 110 may include a memory cell array, an address decoder, an input/output (I/O) circuit block, and the like.

The RF signal unit 120 may receive a signal which is wirelessly transmitted from outside and provide the received signal to the control circuit unit 130. The RF signal unit 120 may wirelessly send a signal provided from the control circuit unit 130. The signals wirelessly transmitted and received through the RF signal unit 120 may be data, an address signal, and a control signal.

The control circuit unit 130 controls operations of the memory circuit unit 110 and the RF signal unit 120.

The semiconductor memory apparatus 10 illustrated in FIG. 1 wirelessly transmits and receives signals to and from an external apparatus such as a central processing unit (CPU), a host computer, or a separate semiconductor memory chip through the RF signal unit 120. Therefore, bandwidths of the RF signals transmitted and received may be easily controlled by manipulating transmission/reception frequency, time duration allotted for transmission/reception, or the like. Thereby, bandwidths may be sufficiently increased.

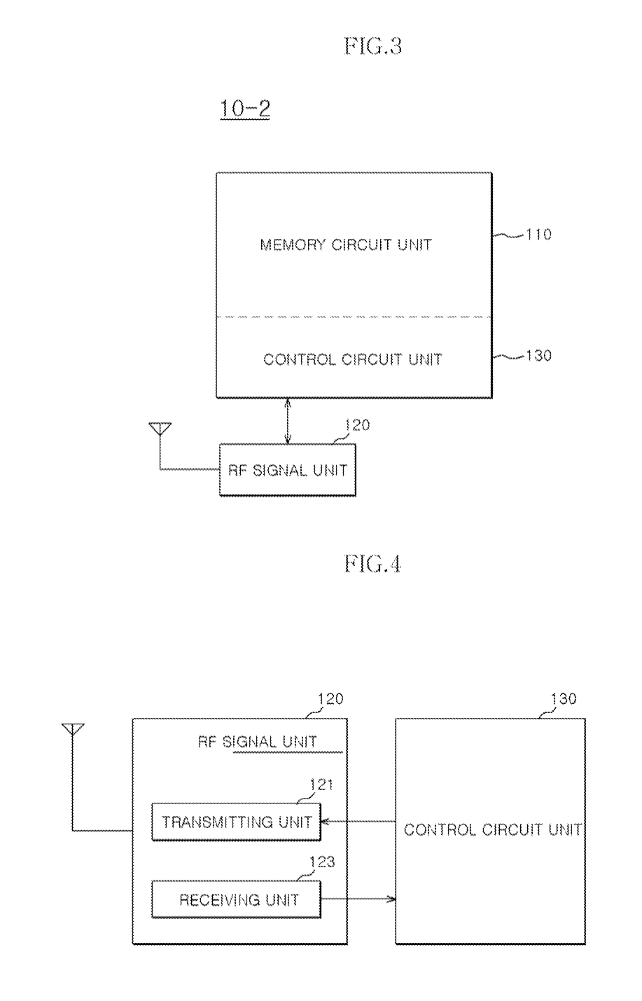

FIG. 2 illustrates another example of a semiconductor memory apparatus 10-1. In the embodiment, a memory circuit unit 110 and an RF signal unit 120 may be formed on the same semiconductor substrate in one chip. A control circuit unit 130 may be formed in a second chip separately from a first chip in which the memory circuit unit 110 and the RF signal unit 120 are formed.

In a semiconductor memory apparatus 10-2 illustrated in FIG. 3, a memory circuit unit 110 and a control circuit unit 130 are formed in a first chip, and an RF signal unit 120 is formed in a second chip.

In the embodiments as described above, at least one of the RF signal unit 120 and the control circuit unit 130 is provided in one chip together with the memory circuit unit 110. The semiconductor memory apparatuses wirelessly transmit and receive data, an address signal, a control signal, or a combination thereof through the RF signal unit 120.

FIG. 4 illustrates a configuration of an RF signal unit and a control circuit unit according to an embodiment.

Referring to FIG. 4, the RF signal unit 120 may include a transmitting unit 121 and a receiving unit 123, The transmitting unit 121 wirelessly sends a signal provided from the control circuit unit 130 to outside. The receiving unit 123 transmits a signal wirelessly received from outside to the control circuit unit 130.

A communication frequency for wirelessly transmitting and receiving signals may be preset according to a bandwidth required for a corresponding semiconductor memory apparatus. A communication method employed by the RF signal unit 120 including the transmitting unit 121 and the receiving unit 123 may be, for example, a wireless short-range communication method. The wireless short-range communication method may implemented by RF, Zigbee, near field communication (NFC), Bluetooth, or the like, but the communication method of the RF signal unit 120 is not limited thereto.

FIG. 5 illustrates a configuration of a control circuit unit according to an embodiment.

The control circuit unit 130 may include a signal processor 1301, a clock generator 1303, and a controller 1305.

The signal processor 1301 may modulate a signal to be transmitted to outside, amplify the modulated signal, and provide the amplified signal to the transmitting unit 121 of the RF signal unit 120. Further, the signal processor 1301 may amplify a signal provided from the receiving unit 123 of the RF signal unit 120, and demodulate the amplified signal. The signal to be transmitted to outside through the signal processor 1301 may be data which is stored in the memory circuit unit 110. The signal provided to the signal processor 1301 through the receiving unit 123 of the RF signal unit 120 may be data which will be stored in the memory circuit unit 110, an address signal, a control signal, or a combination thereof.

The clock generator 1303 may generate a clock signal having a preset frequency required for operations of the RF signal unit 120 and the control circuit unit 130 and provide the clock signal to the RF signal unit 120 and the control circuit unit 130.

The controller 1305 allows an access operation to a memory cell array in the memory circuit unit 110 to be performed in response to a signal provided from the signal processor 1301. The access operation to the memory cell array may include a programming operation, a read operation, a refresh operation, or the like.

In the programming operation, data to be programmed, an address, and a command may be wirelessly received in the receiving unit 123 of the RF signal unit 120 from an external apparatus. Then, the signal processor 1301 of the control circuit unit 130 amplifies the received data, address, and command, and demodulates the amplified data, address, and command. The controller 1305 programs data to a corresponding memory cell in the memory circuit unit 110 in response to the demodulated data, address, and command.

In the read operation, an address of a memory cell, where target data is stored, and a command may be wirelessly received by the receiving unit 123 of the RF signal unit 120 from an external apparatus. Then, the signal processor 1301 of the control circuit unit 130 amplifies the received address and command, and demodulates the amplified address and command. The controller 1305 reads data stored in the corresponding memory cell of the memory circuit unit 110 in response to the demodulated address and command. The read data is modulated and amplified in the signal processor 1301 and wirelessly sent to an external apparatus through the transmitting unit 121.

In this way, since the semiconductor memory apparatuses in the embodiments wirelessly transmit and receive signals, bandwidth of the semiconductor memory apparatuses may increase without additional wiring, and thus the operation speed of the semiconductor memory apparatuses may be improved.

Further, as the semiconductor memory apparatuses are manufactured in a one-chip structure, operation speed may be further improved, and it may also be advantageous in packaging and manufacturing the semiconductor memory apparatuses.

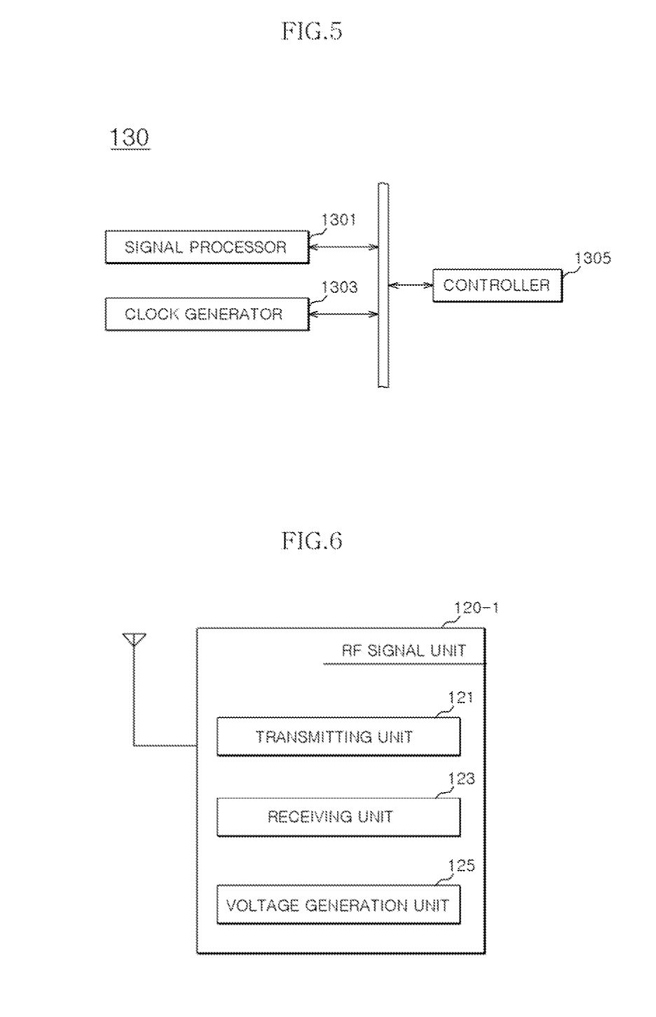

A voltage generation unit, which provides an operation voltage, is necessary to operate the semiconductor memory apparatus. In an embodiment, the voltage generation unit may also be configured together with the semiconductor memory apparatus in one-chip, as illustrated in FIG. 6.

A RF signal unit 120-1 illustrated in FIG. 6 may include a transmitting unit 121 a receiving unit 123, and a voltage generation unit 125.

The voltage generation unit 125 generates operation power in response to a signal which is wirelessly provided from an external apparatus. In an embodiment, the voltage generation unit 125 may be configured to receive an RF signal, multiply the RF signal to a direct current (DC) voltage, and charge (or store) the multiplied voltage. The charged (or stored) voltage may be provided to the memory circuit unit 110, the control circuit unit 130, and the transmitting unit 121 and the receiving unit 123 of the RF signal unit 120-1 to serve as an operation power supply.

Although not shown in FIGS. 1 to 6, the semiconductor memory apparatuses 10, 10-1, and 10-2 may further include a main power supply unit. Even when the main power supply unit is further included, the semiconductor memory apparatuses may be operated using operation power generated and supplied from the voltage generation unit 125, in addition to the main power supply unit. In another embodiment, voltage charged (or stored) in the voltage generation unit 125 may be provided to the main power supply unit. Therefore, even when a power supply from the main power supply unit is interrupted, operation power may be supplied by the voltage generation unit 12 which generates the power using the RF signal. Thus, the power may be continuously supplied to the semiconductor memory apparatuses 10, 10-1, and 10-2.

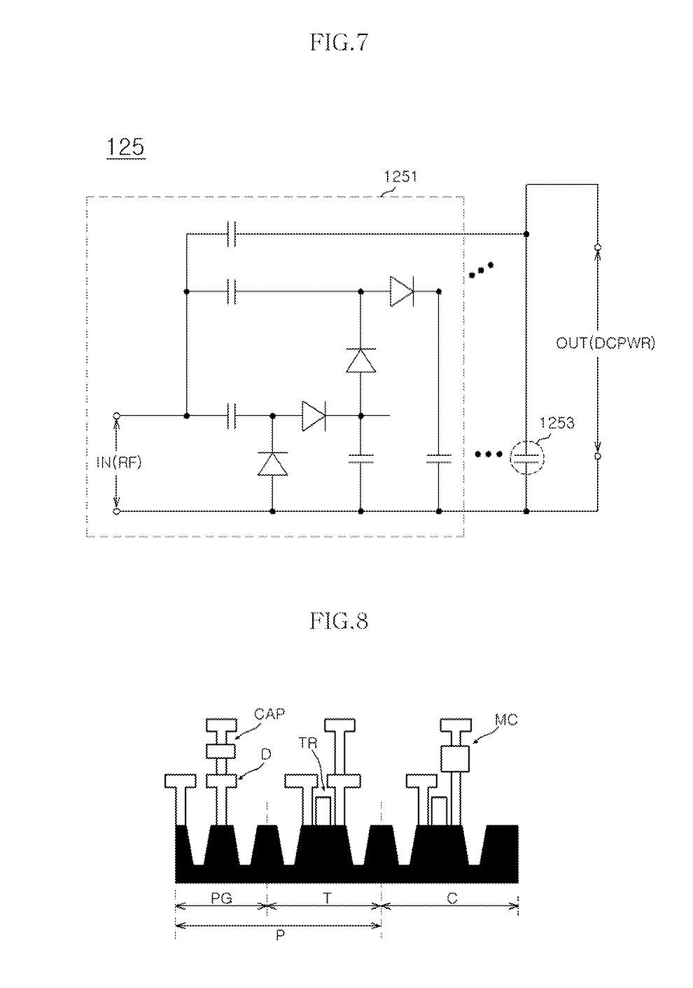

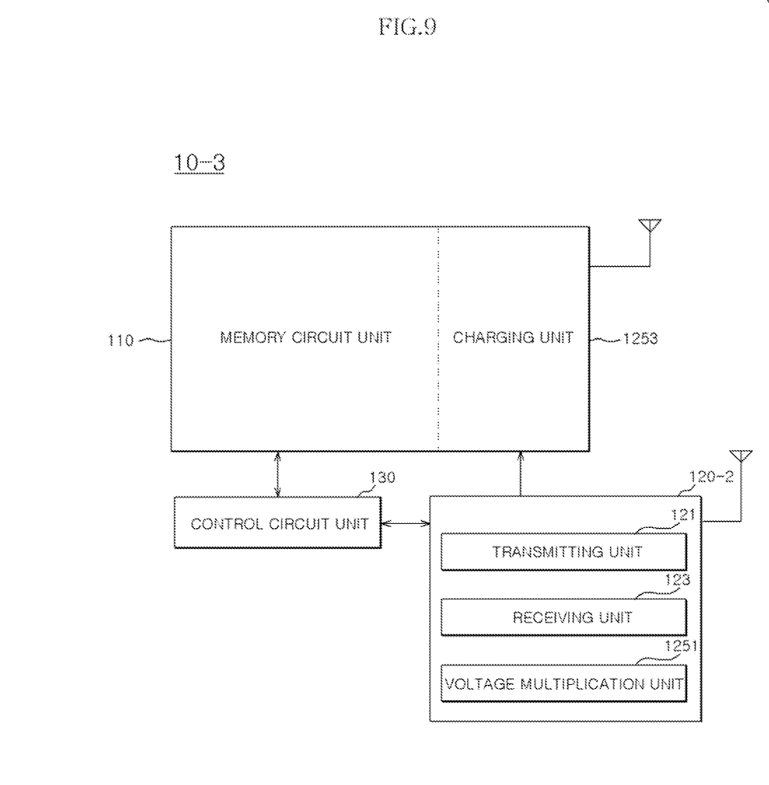

FIG. 7 illustrates a configuration of the voltage generation unit 125 illustrated in FIG. 6.

The voltage generation unit 125 may include a voltage multiplication unit 1251 which receives an RF signal and generates a DC voltage, and a charging unit 1253 which stores the DC voltage which is multiplied by the voltage multiplication unit 1251. An output voltage PWR which is generated in an output terminal OUT of the charging unit 1253 may be provided to the memory circuit unit 110 or the main power supply unit.

The voltage multiplication unit 1251 may serve as an RF-DC converter which converts the RF signal received in an input terminal IN into the DC voltage. When the RF signal is applied to the input terminal IN, a voltage may be multiplied through a rectifying operation of a diode and a boosting operation of a capacitor, and a voltage level may be controlled according to the number of connection stages of the diode and capacitor.

The DC voltage boosted in the voltage multiplication unit 1251 may be stored in the charging unit 1253. The charging unit 1253 may include a storage capacitor. The output voltage PWR of the charging unit 1253 may be used as an operation power supply of a digital circuit unit constituting the memory circuit unit 110 or the control circuit unit 130.

When voltages having levels other than the output voltage PWR which is generated by the voltage multiplication unit 1251 and the charging unit 1253 are used, a signal may be extracted in a middle tap of the voltage multiplication unit 1251. Therefore, when the number of stages of the voltage multiplication unit 1251 is N, DC voltages having N levels may be generated.

The voltage generation unit 1251 may be formed simultaneously when a memory cell array and a peripheral circuit unit of the memory circuit unit 110 are formed to implement the one-chip semiconductor memory apparatuses 10, 10-1, and 10-2.

FIG. 8 is a view illustrating a one-chip structure of a semiconductor memory apparatus according to an embodiment.

Referring to FIG. 8, a memory cell, a peripheral circuit, and a voltage generation unit are formed on a semiconductor substrate in which a cell region C and a peripheral circuit region. P are defined.

The memory circuit unit 110 may be formed on the cell region C and the peripheral circuit region P. The peripheral circuit region P is divided into a digital circuit region T and an analog circuit region PG. A memory cell MC is formed on the cell region C. A digital circuit for a peripheral circuit such as a transistor TR required for an operation of the memory cell MC is formed in the digital circuit region T. The RF signal unit 120 including the voltage generation unit 125 including a diode D and a capacitor CAP may be formed in the analog circuit region PG. Further, the signal processor 1301 and the clock generator 1303 constituting the control circuit unit 130 may be formed in the analog circuit region PG, and the controller 1305 may be formed in the digital circuit region T.

When the memory circuit unit 110 is formed on the semiconductor substrate, the control circuit unit 130 and the RF signal unit 120 are simultaneously formed, and thus the process may be simplified and chip size may be miniaturized. Further, a signal transmitting and receiving speed between the memory circuit unit 110 and the RF signal unit 120 and between the control circuit unit 130 and the RF signal unit 120 may be improved.

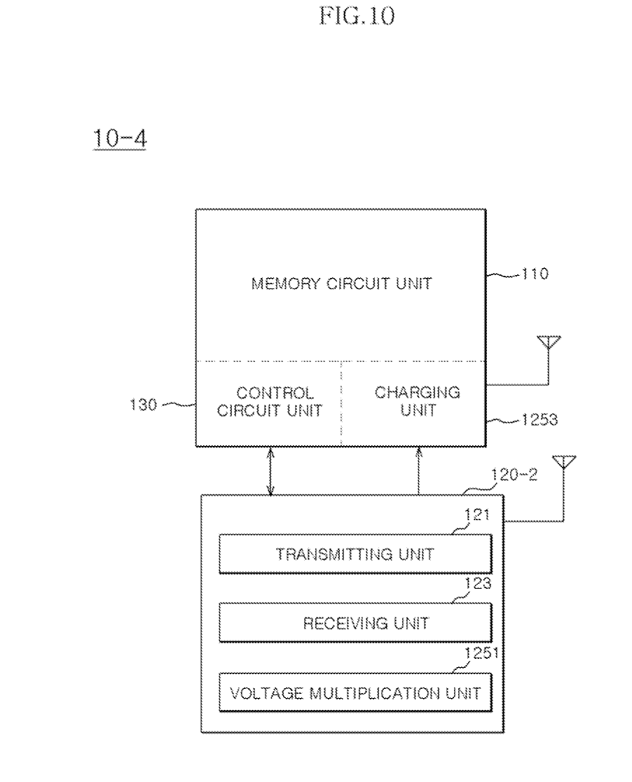

FIGS. 9 and 10 are views illustrating configurations semiconductor memory apparatuses according to embodiments.

In semiconductor memory apparatus 10-3 illustrated in FIG. 9, a memory circuit unit 110 and a charging unit 1253 are formed in one chip. An RF signal unit 120-2, which includes a transmitting unit 121, a receiving unit 123, and a voltage multiplication unit 1251, and a control circuit unit 130 may be formed in a second chip separately from the first chip in which the memory circuit unit 110 and the charging unit 1253 are formed. The control circuit unit 130 and the RE signal unit 120-2 may be formed in a single chip or in different chips.

In a semiconductor memory apparatus 10-4 illustrated in FIG. 10, a memory circuit unit 110, a control circuit unit 130, and a charging unit 1253 are formed in one chip. A RE signal unit 120-2, which includes a transmitting unit 121, a receiving unit 123, and a voltage multiplication unit 1251, may be formed in a separate second chip.

FIGS. 11 to 13 are views illustrating configurations of electronic systems according to embodiments.

An electronic system 20 illustrated in FIG. 11 may include a first chip 210, which includes an RF transceiving unit 211, and a second chip 220 which is configured to wirelessly transmit and receive signals to and from the first chip 210.

The first chip 210 may be, for example, a host apparatus, preferably, a CPU of the host apparatus.

The second chip 220 may be any one of the semiconductor to memory apparatuses illustrated in FIGS. 1 to 10.

The first chip 210 and the second chip 220 mutually transmit and receive signals in a wireless manner.

A plurality of second chips 220 may be provided. Since the first chip 210 and the second chips wirelessly transmit and receive the signals, the bandwidth of the semiconductor memory apparatus may be sufficiently ensured. Therefore, even when the number of second chips 220 increases, signal transmission and reception between the first chip 210 and the second chips 220 may be smoothly performed.

Further, the semiconductor memory apparatus may be configured to mutually transmit and receive signals between the second chips 220 in a wireless manner.

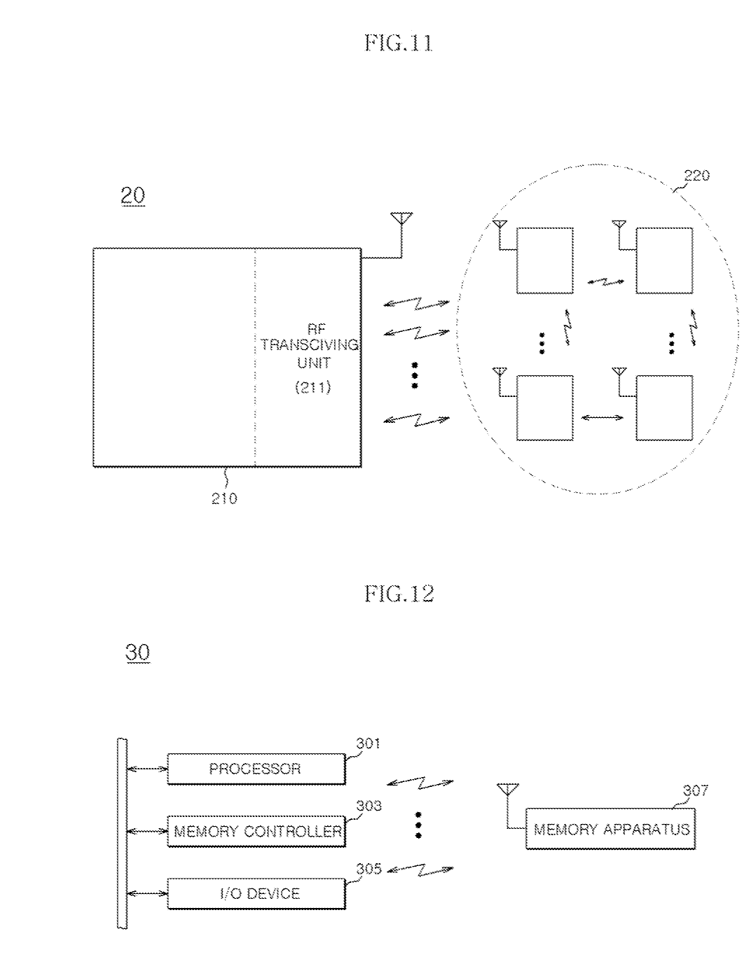

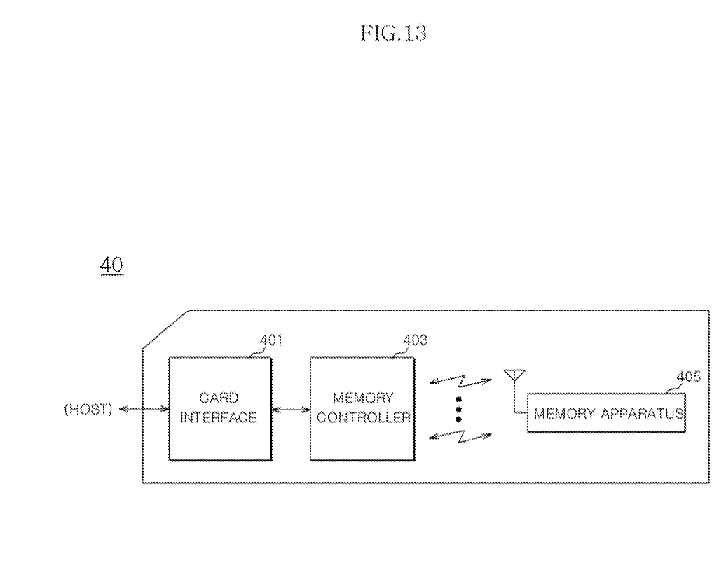

FIG. 12 illustrates an electronic system 30 including a processor 301, a memory controller 303, an I/O device 305, and a memory apparatus 307.

The processor 301 performs decoding of a command input provided from an external apparatus.

The memory controller 303 may be configured to control data processing operation by the memory apparatus 307, for example, programming operation, read operation, refresh operation, or the like according to a control of the processor 301, and further configured to wirelessly transmit and receive signals to and from the memory apparatus 307.

Data programmed in the memory apparatus 307 may be output through the I/O device 305 according to a control of the processor 301 and the memory controller 303. Thus, the I/O device 305 may include a display device, a speaker device, or the like.

The I/O device 305 may include an input device. The I/O device 305 may input a control signal for controlling an operation by the processor 301 or data, which will be processed by the processor 301, through the input device.

In another embodiment, the memory controller 303 may be implemented as part of the processor 301. In yet another embodiment, the memory controller 303 may be formed on a chip different from a separate chip where the processor 301 is provided.

The memory apparatus 307 may be any one of the semiconductor memory apparatuses illustrated in FIGS. 1 to 10. Therefore, the memory apparatus 307 and the memory controller 303 may mutually transmit and receive signals in a wireless manner.

The electronic system 30 illustrated in FIG. 12 may further include a communication module (not shown). The communication module may access to a wired or wireless communication network and provide a communication environment for exchanging data and a control signal. When the electronic system 30 includes the communication module, the electronic system 30 illustrated in FIG. 12 may be a portable communication apparatus such as a wireless communication terminal.

An electronic system 40 illustrated in FIG. 13 may include a card interface 401, a memory controller 403, and a memory apparatus 405.

The electronic system 40 illustrated in FIG. 13 may be an example of a memory card or a smart card, and include any one of a portable computer (PC) card, a multimedia card, an embedded multimedia card, a secure digital card, and a universal serial bus (USB) drive.

The card interface 401 interfaces data exchange between a host and the memory controller 403 according to a protocol of the host. In an embodiment, the card interface 401 may be referred to as hardware which may support a protocol used in the host, software installed in the hardware for supporting the protocol used in the host, or a signal transmission method.

The memory controller 403 may be configured to control data exchange between the memory apparatus 405 and the card interface 401, and wirelessly transmit and receive signals to and from the memory apparatus 405.

The memory apparatus 405 may be, for example, any one of the semiconductor memory apparatuses illustrated in FIGS. 1 to 10. That is, the memory apparatus 405 may be configured to wirelessly transmit and receive signals and to wirelessly communicate with the memory controller 403,

The above embodiments of the present invention are illustrative and not limitative. Various alternatives and modifications are possible.

What is claimed is:

1. A semiconductor memory apparatus comprising;
a memory circuit unit;
a radio frequency (RF) sign unit suitable to wirelessly transmit and receive a first signal; and
a control circuit unit suitable to access the memory circuit unit in response to a second signal received through the RF signal unit and further suitable to provide data of the memory circuit unit to the RF signal unit,
wherein at least one of the RF signal unit and the control circuit unit is provided in a single chip together with the memory circuit unit.

2. The semiconductor memory apparatus of claim 1, wherein the memory circuit unit and the RF signal unit are formed in a first chip, and
wherein the control circuit unit is formed in a second chip.

3. The semiconductor memory apparatus of claim 1, wherein the memory circuit unit and the control circuit unit are formed in a first chip, and
wherein the RF signal unit is formed in a second chip.

4. The semiconductor memory apparatus of claim 1 wherein the RF signal unit includes:
a transmitting unit suitable to wirelessly transmit a third signal which is provided from the control circuit unit; and
a receiving unit suitable to wirelessly receive a fourth signal from an external apparatus and provide the fourth signal to the control circuit unit.

5. The semiconductor memory apparatus of claim 4, wherein the RF signal unit further includes a voltage generation unit, and
wherein the voltage generation unit is suitable to generate an operation voltage in response to a fifth signal wirelessly provided from the external apparatus.

6. The semiconductor memory apparatus of claim 5, wherein the voltage generation unit includes:
a voltage multiplication unit suitable to generate a direct current (DC) voltage and boost the generated DC voltage in response to a sixth signal wirelessly provided from the external apparatus; and
a charging unit suitable to store the DC voltage boosted in the voltage multiplication unit and provide the DC voltage as an operation voltage.

7. The semiconductor memory apparatus of claim 6, wherein the memory circuit unit and the charging unit are formed in a first chip, and
wherein the control circuit unit, the transmitting unit, the receiving unit, and the voltage multiplication unit are formed in a second chip different from the first chip.

8. The semiconductor memory apparatus of claim 6, wherein the memory circuit unit, the control circuit unit, and the charging unit are formed in a first chip, and
wherein the transmitting unit, the receiving unit, and the voltage multiplication unit are formed in a second chip different from the first chip.

9. The semiconductor memory apparatus of claim 1, wherein the control circuit unit includes:
a signal processor suitable to modulate a seventh signal, which is to be transmitted to an external apparatus, provide the modulated signal to the RF signal unit, and demodulate an eighth signal which is provided from the RF signal unit;
a clock generator suitable to generate a clock signal and provide the clock signal to the RF signal unit; and
a controller suitable to access the memory circuit unit in response to a ninth signal provided from the signal processor.

10. An electronic system comprising:
a first chip including a radio frequency (RF) signal unit; and
at least one second chip suitable to wirelessly transmit a first signal to the first chip and receive a second signal from the first chip,
wherein the second chip includes:
a memory circuit unit;
a radio frequency (RF) signal unit configured to wirelessly transmit a third signal and receive a fourth signal; and
a control circuit unit configured to access the memory circuit unit in response to a fifth signal received through the RF signal unit and provide data of the memory circuit unit to the RF signal unit,
wherein at least one of the RF signal unit and the control circuit unit is provided in a single chip together with the memory circuit unit.

11. The electronic system of claim 10, wherein a plurality of second chips mutually transmit and receive a sixth signal with each other, and with the first chip.

12. The electronic system of claim 10 wherein the first chip is a host apparatus.

13. The electronic system of claim 10, wherein the RF signal unit includes:
a transmitting unit suitable to wirelessly send a seventh signal provided from the control circuit unit; and
a receiving unit suitable to wirelessly receive an eighth signal from an external apparatus and provide the eighth signal to the control circuit unit.

14. The electronic system of claim 13, wherein the RF signal unit further includes a voltage generation unit, and
wherein the voltage generation unit is suitable to generate an operation voltage in response to a ninth signal wirelessly provided from the external apparatus.

15. The electronic system of claim 14, wherein the voltage generation unit includes:
a voltage multiplication unit suitable to generate a direct current (DC) voltage and boost the generated DC voltage in response to a tenth signal wirelessly provided from the external apparatus; and
a charging unit suitable to store the DC voltage boosted in the voltage multiplication unit and provide the stored DC voltage as the operation voltage.

16. The electronic system of claim 10, wherein the control circuit unit includes:
a signal processor suitable to modulate an eleventh signal, which is to be transmitted to an external apparatus, provide the modulated signal to the RF signal unit, and demodulate a twelfth signal provided from the RF signal unit;
a clock generator suitable to generate a clock signal and provide the clock signal to the RF signal unit; and
a controller suitable to access the memory circuit unit in response to a thirteenth signal provided from the signal processor.

17. An electronic system comprising:
a processor suitable to decode a command input provided from an external apparatus;
a memory controller suitable to wirelessly transmit and receive a first signal to and from a memory apparatus according to control of the processor; and
a memory apparatus, wherein the memory apparatus includes:
a memory circuit unit,
a radio frequency (RF) signal unit suitable to wirelessly transmit and receive a second signal to and from the memory controller, and
a control circuit unit suitable to access the memory circuit unit in response to a third signal received through the RF signal unit and provide data of the memory circuit unit to the RF signal unit,
wherein at least one of the RF signal unit and the control circuit unit is provided in a single chip together with the memory circuit unit.

18. An electronic system comprising:
a memory apparatus, wherein the memory apparatus includes:
a memory circuit unit,
a radio frequency (RF) signal unit suitable to wirelessly transmit and receive a first signal, and
a control circuit unit suitable to access the memory circuit unit in response to a second signal received through the RF signal unit and provide data of the memory circuit unit to the RF signal unit,
wherein at least one of the RF signal unit and the control circuit unit is provided on a single chip together with the memory circuit unit;
a memory controller suitable to wirelessly transmit and receive a third signal to and from the control circuit unit, and control operation of the memory apparatus; and
a card interface suitable to perform a data exchange between a host and the memory controller.
